(19) United States
(12) Patent Application Publication
(10) Pub. No.: US 2026/0086402 A1
(43) Pub. Date: Mar. 26, 2026

(54) TRANSPARENT SELF-EMISSIVE DISPLAYS WITH AN ELECTRICALLY CONTROLLABLE OPACITY LAYER FOR INCREASED CONTRAST

(71) Applicant: Intel Corporation, Santa Clara, CA (US)

(72) Inventors: Ramon C. Cancel Olmo, Hillsboro, OR (US); Kunjal S. Parikh, Fremont, CA (US); Khaled Ahmed, San Jose, CA (US); Roland P. Wooster, Folsom, CA (US)

(73) Assignee: Intel Corporation, Santa Clara, CA (US)

(21) Appl. No.: 19/252,249

(22) Filed: Jun. 27, 2025

Related U.S. Application Data
(60) Provisional application No. 63/698,663, filed on Sep. 25, 2024.

(51) Int. Cl. G02F 1/1334; G02F 1/13357; G02F 1/157

(52) U.S. Cl. CPC G02F 1/1334; G02F 1/133603; G02F 1/157; G02F 2201/44

(57) ABSTRACT

In embodiments herein, a self-emissive display panel includes layer comprising a material with electrically controllable opacity, which can be switched between being substantially transparent and substantially opaque, e.g., to provide increased contrast for the display panel. The electrically switchable layer may include, for example, electrochromic glass or a layer of polymer-dispersed liquid crystals (PDLC).

### CROSS-REFERENCE TO RELATED APPLICATIONS

This application claims the benefit of and priority to U.S. Provisional Patent Application Ser. No. 63/698,663, filed Sep. 25, 2024 and entitled “TRANSPARENT SELF-EMISSIVE DISPLAYS WITH LIQUID CRYSTAL LAYERS FOR INCREASED CONTRAST,” the disclosure of which is considered part of and hereby incorporated by reference in its entirety in the disclosure of this application.

### BACKGROUND

Self-emissive displays include pixel elements (or sub-pixel elements) that emit their own light. Examples of self-emissive display technologies include organic light-emitting diode (OLED) displays and micro-LED (uLED) displays. Transparent self-emissive displays implement their emissive pixel or sub-pixel elements on a transparent or near-transparent substrate. However, because of this, the displays may suffer from low contrast.

### BRIEF DESCRIPTION OF THE DRAWINGS

FIGS. 1A-1B illustrate example structures for organic light-emitting diode (OLED)-based display panels comprising a controllable opacity layer in accordance with embodiments of the present disclosure.

FIGS. 2A-2B illustrate example structures for micro light-emitting diode (uLED)-based display panels comprising a controllable opacity layer in accordance with embodiments of the present disclosure.

FIG. 3 illustrates an example self-emissive display structure switching between a transparent state and an opaque state according to embodiments of the present disclosure.

FIG. 4 illustrates an example transparent self-emissive display of the present disclosure, with certain regions of the display having a controllable opacity layer activated for enhanced contrast in those regions.

FIG. 5 illustrates a flow diagram of an example process of selectively enhancing contrast in a transparent display of the present disclosure.

FIG. 6 illustrates a simplified block diagram of a computing device in which aspects of the present disclosure may be incorporated.

FIG. 7 is a block diagram of computing device components which may be included in a mobile computing device incorporating aspects of the present disclosure.

### DETAILED DESCRIPTION

In the following description, specific details are set forth, but aspects of the technologies described herein may be practiced without these specific details. Well-known circuits, structures, and techniques have not been shown in detail to avoid obscuring an understanding of this description.

In the present disclosure, the phrases “an embodiment,” “various embodiments,” “certain embodiments,” “some embodiments,” and the like may include features, structures, or characteristics, but not every embodiment necessarily includes the particular features, structures, or characteristics. Some embodiments may have some, all, or none of the features described for other embodiments. Moreover, these (or similar) phrases may refer to one or more of the same or different embodiments. The terms “comprising,” “including,” “having,” and the like, as used with respect to aspects of the present disclosure, may be synonymous. The terms “first,” “second,” “third,” and the like may be used to describe a common object and indicate different instances of like objects being referred to. Such adjectives do not imply objects so described must be in a given sequence, either temporally or spatially, in ranking, or any other manner.

Further, the terms “over,” “under,” “between,” “above,” and “on” as used herein may refer to a relative position of one material layer or component with respect to other layers or components. For example, one layer disposed over or under another layer may be directly in contact with the other layer or may have one or more intervening layers. Moreover, one layer disposed between two layers may be directly in contact with the two layers or may have one or more intervening layers. In contrast, a first layer “on” a second layer is in direct contact with that second layer. Similarly, unless explicitly stated otherwise, one feature disposed between two features may be in direct contact with the adjacent features or may have one or more intervening features.

The term “adjacent” as used herein may refer to layers or components that are in physical contact with each other. That is, there is no layer or component between the stated adjacent layers or components. For example, a layer X that is adjacent to a layer Y refers to a layer that is in physical contact with layer Y. “Connected” may indicate elements are in direct physical or electrical contact with each other and “coupled” may indicate elements co-operate or interact with each other, but they may or may not be in direct physical or electrical contact. “Electrically connected” may refer to two elements that are electrically conductively coupled to one another; that is, there are one or more electrically conductive paths between the elements recited as being electrically connected.

Terms modified by the word “substantially” include arrangements, orientations, spacings, positions, or characteristics (e.g. of a material) that vary slightly from the meaning of the unmodified term. For example, the term “substantially transparent” as used herein may refer to a material layer that has greater than 80% transparency/transmissivity of light, rather than 100% transmissivity. Similarly, the terms “about” or “approximately” may refer to values or characteristics that are within a close range of the modified term. For example, “approximately X” or “about X” may refer to a value of that is +/−10% of the value “X”.

Reference is now made to the drawings, which are not necessarily drawn to scale, wherein similar or same numbers may be used to designate same or similar parts in different figures. The use of similar or same numbers in different figures does not mean all figures including similar or same numbers constitute a single or same embodiment. Like numerals having different letter suffixes may represent different instances of similar components. The drawings illustrate generally, by way of example, but not by way of limitation, various embodiments discussed in the present document.

In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives within the scope of the claims.

Transparent Self-Emissive Displays with Electrically Controllable Opacity Layer

Displays with the highest contrast ratios tend to be self-emissive displays, e.g., OLED or uLED displays. This is because, unlike traditional liquid crystal displays (LCDs), self-emissive displays do not require the use of a backlight to reproduce colors. Self-emissive displays turn on/off individual pixel elements or sub-pixel elements to represent colors, and simply turn off the emissive elements to display black content. In contrast, LCDs use a backlight that emits light that is passed through a layer of liquid crystals. When displaying black content, the LCD backlight may still be on, leading to some amount of bleed-through of the backlight through the liquid crystal layer when displaying black content. This leads to a reduction in the contrast ratio of an LCD display as opposed to self-emissive displays like OLED or uLED displays. While LCD displays can be improved through the use of light arrays or segmented back lights that are selectively dimmed or turned on/off, self-emission is still a superior display approach to these technologies in regards to contrast.

Recently, some self-emissive display technologies have been developed to provide some amount of transparency through the display, e.g., for signage or heads-up displays (HUDs). These transparent or semi-transparent self-emissive displays, however, can suffer from lower contrast ratios due to their transparent or near transparent substrates, which allow light to pass through the substrate in the direction of the viewer when the emissive elements are turned off. Because of this, a transparent display might not able to reproduce black or near-black color pixels, as a pixel that is “off” in a self-emissive display will allow the viewer to see through the display and observe whatever is behind the display. This can limit the potential use cases for transparent displays, with typical uses being related to smart displays, signage, and/or novelty applications.

Aspects of the present disclosure provide techniques for adding opacity to transparent self-emissive displays to improve the contrast ratio of the displays, which can make them more feasible for existing or new use cases (e.g., movie-watching, reading, or working) while still retaining transparency capabilities that make it an aesthetically attractive solution for certain applications. The opacity may be controlled at the pixel level, in certain embodiments, allowing for fine control of the contrast ratio of the display. In certain embodiments, for example, transparent self-emissive display, such as a uLED and OLED display panel, may incorporate a strategically placed layer within the display panel stack that is electrically controllable to modify the opacity of the display panel (or pixel(s) of the panel). The controllable opacity layer may accordingly function as a dynamic opacity modulator, controlling the amount of light that passes through the display at the pixel level (and thus, also at the overall display level).

For instance, in some embodiments, the controllable opacity layer may include an electrochromic material (e.g., electrochromic glass) that is electrically controllable to provide a transparency as clear as up to 80-90% transmission and an opacity of down to approximately 0.01% transmission, which can provide a generally black background on the display (with a contrast ratio of 8000:1-9000:1). In other embodiments, the controllable opacity layer may be a liquid crystal layer that is controllable in a similar manner. The controllable opacity layer can be switched at the pixel level in certain embodiments, allowing for selective darkening of pixels or areas of the display to produce deeper blacks and richer contrast. Accordingly, embodiments herein may effectively mitigate the inherent transparency of self-emissive displays that typically leads to washed-out images due to ambient light interference or light pass-through as described above.

Additionally, certain embodiments of the present disclosure may utilize artificial intelligence (AI) or other types of algorithms to analyze content to be displayed, ambient lighting conditions, or other aspects in real-time, enabling a system to utilize the controllable opacity layer to dynamically adapt a self-emissive display panel for contrast enhancement. Such embodiments can be implemented within software, hardware, firmware, or a combination thereof. For instance, certain embodiments can be implemented in code embedded within and/or executed by a graphics processing unit (GPU) of a computer system.

While each of the examples described below include certain layers or components, it will be understood that embodiments of the present disclosure may include additional, fewer, or other layers or components than those shown.

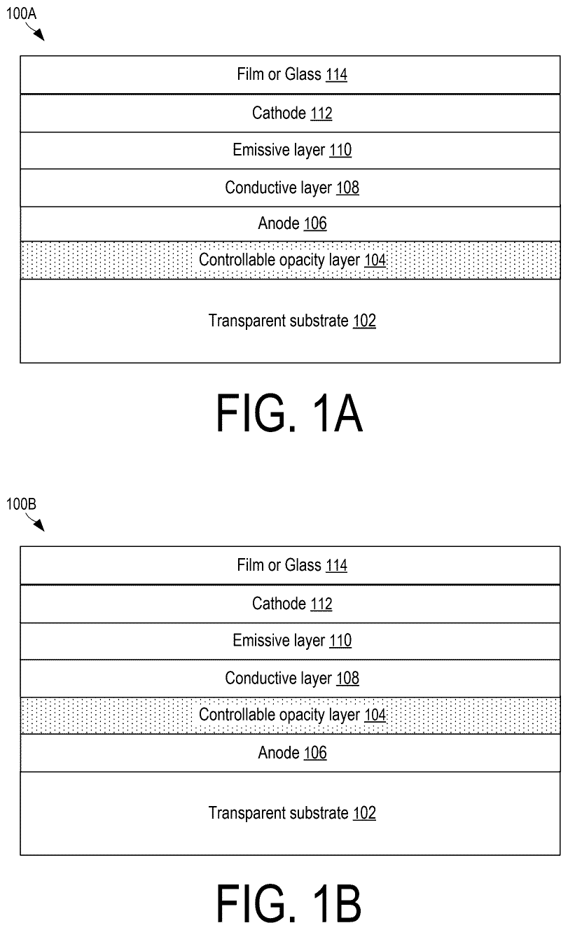

FIGS. 1A-1B illustrate example structures 100A, 100B for organic light-emitting diode (OLED)-based display panels comprising a controllable opacity layer in accordance with embodiments of the present disclosure. In particular, the structures 100A, 100B may represent a cross-sectional layer stack for OLED-based display panels according to the present disclosure.

The display panel structures 100A, 100B include a substrate 102. In certain embodiments, the substrate 102 may be composed of or include glass or plastic. The substrate 102 may be rigid or may be flexible. The structure 100A of FIG. 1A also includes a controllable opacity layer 104 on the substrate 102 and a conductive anode 106 on the controllable opacity layer 104, while the structure 100B of FIG. 1B includes the controllable opacity layer 104 on the anode 106, which is on the transparent substrate 102. Each structure 100A, 100B further includes a conductive layer 108, an emissive layer 110, and a conductive cathode 112 on the emissive layer 110. The conductive layer 108 and emissive layer 110 may be formed of any suitable materials that are typically used in OLED displays. Each structure 100A, 100B also includes a layer 114 of film or glass above the cathode 112, which may act as a protective layer or provide other advantages (e.g., anti-reflection).

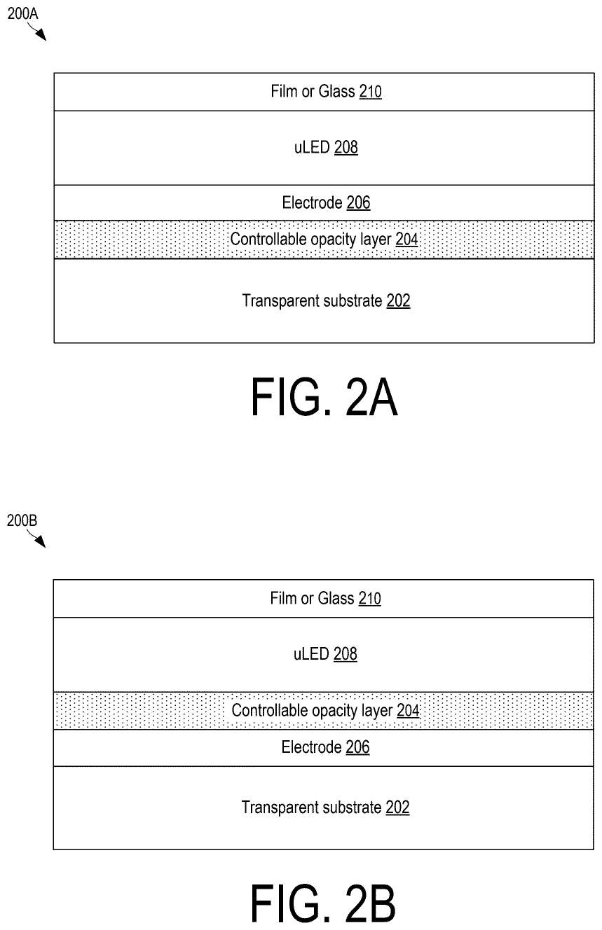

FIGS. 2A-2B illustrate example structures 200A, 200B for micro light-emitting diode (uLED)-based display panels comprising a controllable opacity layer in accordance with embodiments of the present disclosure. In particular, the structures 200A, 200B may represent a cross-sectional layer stack for uLED-based display panels according to the present disclosure. The display panel structures 200A, 200B include a substrate 202. In certain embodiments, the substrate 202 may be composed of or include glass or plastic. The substrate 202 may be rigid or may be flexible. The structure 200A of FIG. 2A includes a controllable opacity layer 204 on the substrate 202, while the structure 200B of FIG. 2B includes an electrode 206 on the substrate 202 and the controllable opacity layer 204 on the electrode 206. The structures 200A, 200B include a microLED (or uLED) layer 208 that includes the self-emissive microLEDs. The structures 200A, 200B further include a top layer 210 of film or glass, which may act as a protective layer or provide other advantages (e.g., anti-reflection).

In each example shown, the layers may collectively be substantially transparent; that is, the full stack shown in each example may be substantially transparent (when the layers 104, 204 are controlled to be transparent). As used herein, “substantially transparent” may refer to a material having a transmissivity of greater than 80% (e.g., greater than 90%). The controllable opacity layers 104, 204 may be configured to have their transmissivity/opacity electrically switched or controlled by controller circuitry. For example, in some embodiments, the layers 104, 204 may be controllable to have a transmissivity below about 10% (generally opaque) or above about 70% (generally transparent). In some cases, the material of the layers 104, 204 may be controllable to have a transmissivity that is between 10%-70% as well. For instance, the layers 104, 204 may be controllable to have their transmissivity be any number of values between 1% and 80%. In some cases, the layers 104, 204 may be able have their transmissivity controlled to an opacity anywhere between approximately 0.01% and approximately 90%.

The controllable opacity layers 104, 204 may be implemented using electrochromic materials or liquid crystals. For example, in some embodiments, electrochromic glass (also sometimes referred to as smart glass) may be used as the controllable opacity layer 104 or 204. In other embodiments, the controllable opacity layer 104, 204 may be implemented using polymer-dispersed liquid crystals (PDLC). In some cases, the layers 104, 204 may be able have their transmissivity controlled to an opacity between approximately 0.01% and approximately 80% (or higher).

The layers 104, 204 may be controllable at a per-pixel level, while other embodiments may control the layers 104, 204 at a per-region or per-panel level. In certain cases, control of the layers 104, 204 may be adjacent to an electrode in the structure so that electrical connections may be shared or run in parallel with one another. For instance, in each example above, the controllable opacity layer is adjacent an electrical layer comprising electrical connections within the stack, e.g., adjacent the anode 106 or electrode 206. In such embodiments, the anode or electrode layer (or portions thereof) can be used to switch the controllable opacity layer adjacent to it. However, in other embodiments, the controllable opacity layer may be somewhere else in the stack and might not be adjacent to an electrical layer of the stack.

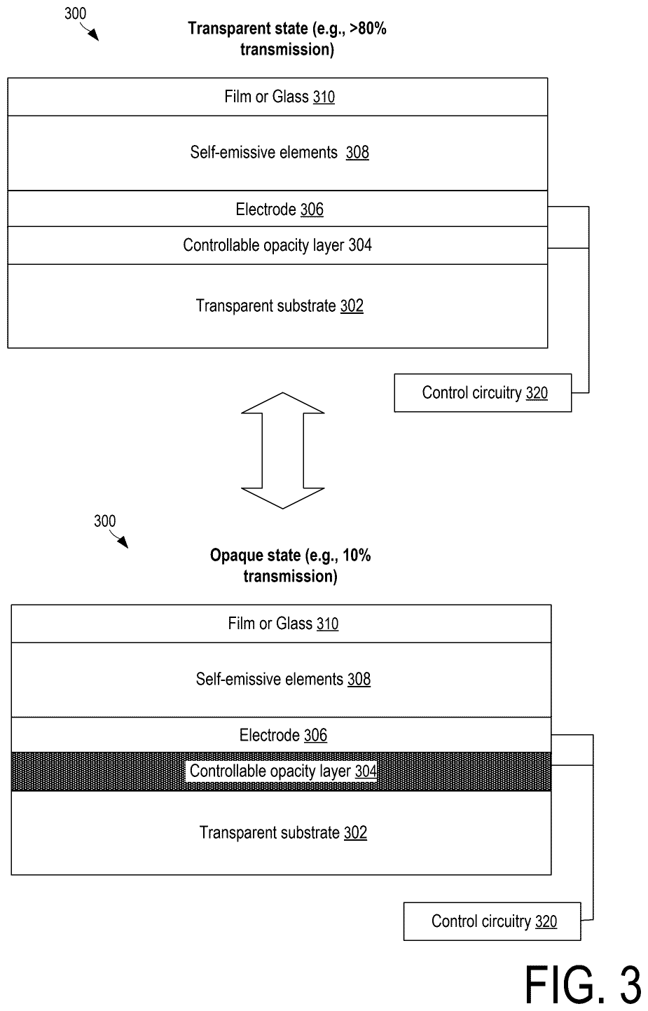

FIG. 3 illustrates an example self-emissive display structure 300 switching between a transparent state and an opaque state according to embodiments of the present disclosure. The example display structure 300 includes a substantially transparent substrate 302, controllable opacity layer 304, a substantially transparent electrode layer 306, substantially transparent self-emissive elements 308 (e.g., OLED or uLED elements), and a top layer 310 of film or glass. Each of these components may be implemented in the same or similar manner as the corresponding elements described above. For instance, the substrate 302 may be the same as or similar to the substrates 102, 202, the layer 304 may be the same as or similar to the layers 104, 204, the electrode layer 306 may be the same as or similar to the electrode 206 or the anode 106, and the layer 310 may be the same as or similar to the layers 114, 210.

As shown, the controllable opacity layer 304 can be switched between a generally transparent state to a more opaque state, in which the layer 304 blocks light going through the panel. More particularly, in various embodiments, the control circuitry 320 coupled to the layer 304 may send electrical signal to the layer 304 to cause it to be in the substantially transparent state (e.g., where the stack has a transmissivity greater than 80%, e.g., greater than 90%), in a substantially opaque state (e.g., where the stack has a transmissivity of less than 10%, e.g., less than 5%), or somewhere in between. For instance, the control circuitry 320 may switch between the states shown, or may control the layer 304 to be at any number of states between those shown. In some cases, the opacity may be controlled in a binary, on/off manner, while in other cases, the opacity may be controlled to any transmissivity within a range. In some embodiments, the control circuitry may be implemented within a timing controller (TCON) of a display panel.

The control circuitry 320 may be able to modify the opacity of the layer 304 at the pixel level, per-region, or otherwise. For instance, in some embodiments, the controllable opacity layer could be used to increase opacity within certain targeted pixels or regions to better reproduce dark content, reducing the effects of ambient light and other bleed-through, helping to increase contrast ratio. For example, in signage applications, aspects of the present disclosure can be used to increase the readability of material by blocking light precisely behind text or other characters. In addition, aspects of the present disclosure can be used to strategically increase contrast, where darker content is present (and thus, less light is being emitted). Further, aspects of the present disclosure could be used to increase the contrast within a scene, such as behind the silhouette of an individual or a particular object.

Aspects of the present disclosure could also allow for transparent displays to be more suitable for more common display applications, such as office work, reading, or content watching. For example, a display of the present disclosure may be coupled to a window and used during the daytime to take advantage of the sun's brightness as a backlight for the display, while being able to selectively make certain pixels of the display substantially black, leading to an overall contrast ratio that is much higher than electrically backlit displays.

Control of this controllable opacity layer may, in certain embodiments, be implemented by code within the GPU or other processor/accelerator of a computing system. Some embodiments may may leverage artificial intelligence (AI), e.g., deep neural networks (DNNs) or convolutional neural networks (CNNs) to identify certain identities, images, facial expressions, etc., or other algorithms to further optimize displayed content for readability or viewability. In certain embodiments, these algorithms could analyze scenes or other content of a frame to determine when or how to utilize the controllable opacity layer to enhance contrast of one or more regions of the display. For example, some embodiments may analyze live content to determine areas of a frame (e.g., faces, certain objects such as balls in sporting events, etc.) in which to enhance contrast, or determine where text is shown and enhance contrast in the area around the font.

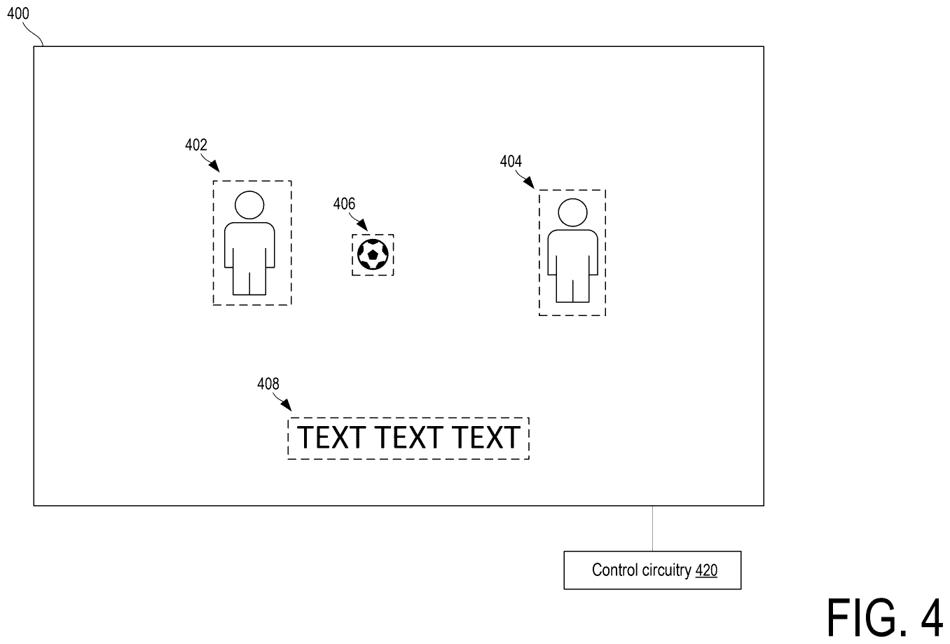

FIG. 4 illustrates an example transparent self-emissive display 400 of the present disclosure, with certain regions of the display having a controllable opacity layer activated for enhanced contrast in those regions. In the example shown, a control algorithm can be implemented within the control circuitry 420 and used to switch the controllable opacity layer of the display to enhance contrast in one or more of the areas 402, 404, 406, 408 as described above. For instance, in the example shown, there are two people (in areas 402, 404) playing a game with a ball (in the area 406) with text being displayed at the bottom of the display 400 (in the area 408). Each of these areas may be particularly of interest of a viewer (relative to other areas of the display), so in certain embodiments, one or more of these regions of the display can have their controllable opacity layer modify its opacity (e.g., as shown in FIG. 3) to enhance contrast around the people, ball, and/or text. An AI-based algorithm or other type of algorithm may be used to analyze the content being displayed to determine particular areas of frames that might be useful for contrast enhancement, and to accordingly activate the controllable opacity layer in regions of the display that are showing those particular areas of the frame.

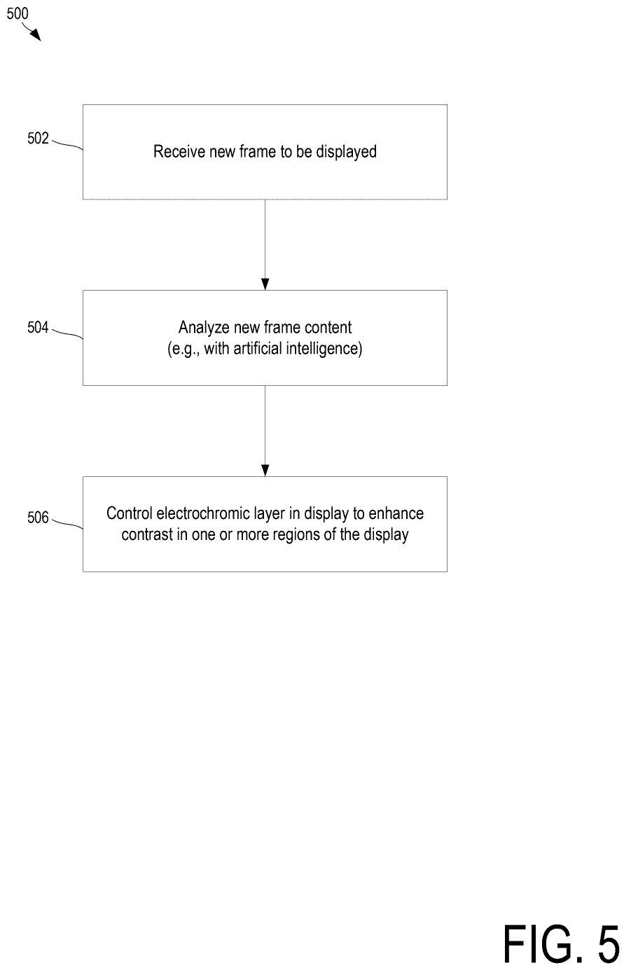

FIG. 5 illustrates an example process 500 of selectively enhancing contrast in a transparent display of the present disclosure. The process 500 may include additional, fewer, or different operations than those shown or described below, and some operations may be repeated. In addition, some of the operations of the process 500 may be performed simultaneously or at least partially in parallel with one another. In some embodiments, one or more of the operations shown include multiple operations, sub-operations, etc. Particular embodiments may include hardware circuitry, firmware, software, or some combination thereof to implement one or more of the operations shown. In some embodiments, instructions may be encoded one or more computer-readable media so that, when executed, the instructions implement one or more of the operations shown.

At 502, a control algorithm (e.g., being executed in a graphics processing unit (GPU) or other processing circuitry based on encoded instructions) receives a new frame that is to be displayed on a transparent self-emissive display panel that includes a controllable opacity layer as described herein. At 504, the algorithm analyzes the frame content, which may include content of previous or next frames in the sequence, to determine whether there are particular areas of the display at which the controllable opacity layer may be utilized to enhance contrast for an enhanced user experience (e.g., as described above). At 506, the algorithm activates one or more pixels of the controllable opacity layer of the display panel to enhance contrast based on the analysis at 504.

### Example Computing Systems

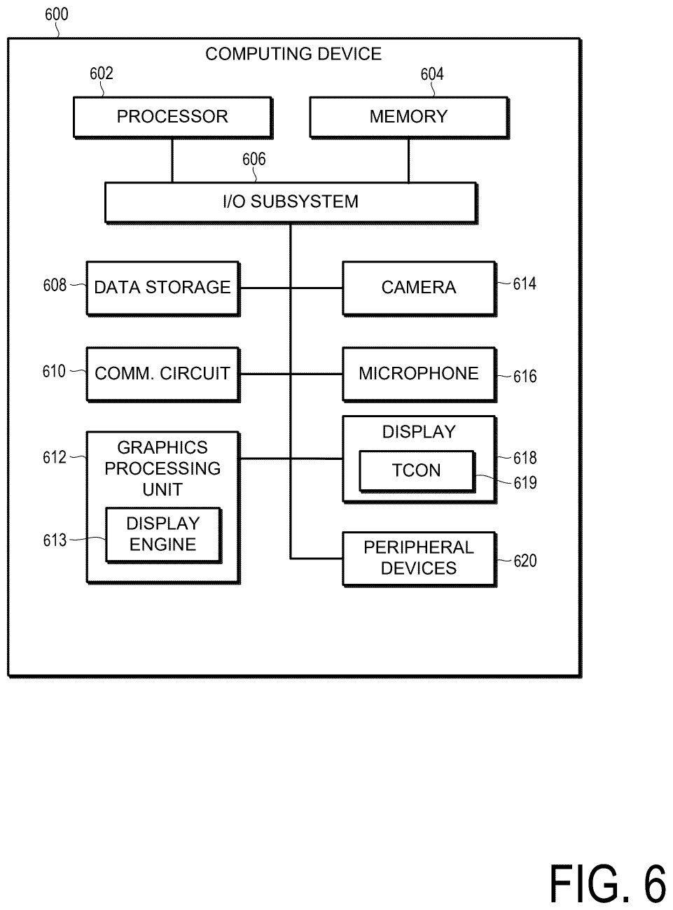

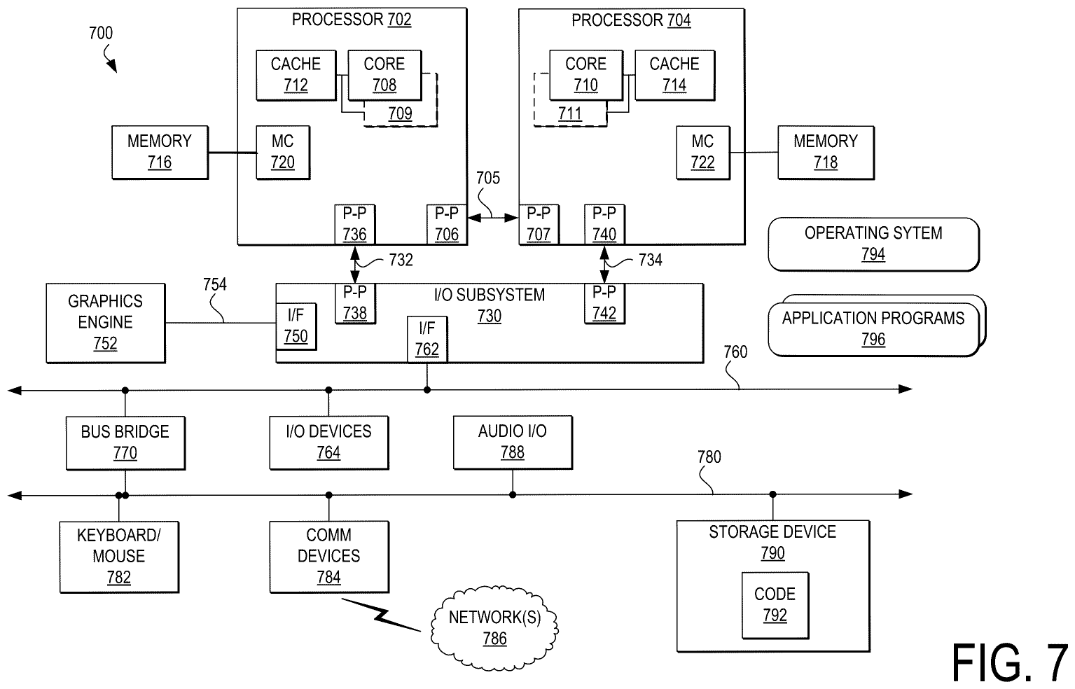

FIGS. 6-7 illustrate example computing systems that can implement aspects of the present disclosure. For instance, a display as described above may be implemented in the display 618 and the dynamic control aspects of the process 500 of FIG. 5 can be implemented in code within the graphics processing unit 612 and/or graphics engine 752.

FIG. 6 illustrates a simplified block diagram of a computing device in which aspects of the present disclosure may be incorporated. The computing device 600 for selective updating of a display is shown. In use, the illustrative computing device 600 determines one or more regions of a display to be updated. For example, a user may move a cursor and a clock may change from one frame to the next, requiring an update to two regions of a display. The computing device 600 sends update regions from a source to a sink in the display 618 over a link. In the illustrative embodiment, the source does not have direct access to the link port while the sink does have direct access to the link port. The source can send an indication that a particular update message is the last message to be sent for the current frame, after which the source will be entering an idle period without sending update messages. The sink can then place the link in a low-power state to reduce power usage.

The computing device 600 may be embodied as any type of computing device. For example, the computing device 600 may be embodied as or otherwise be included in, without limitation, a server computer, an embedded computing system, a System-on-a-Chip (SoC), a multiprocessor system, a processor-based system, a consumer electronic device, a smartphone, a cellular phone, a desktop computer, a tablet computer, a notebook computer, a laptop computer, a network device, a router, a switch, a networked computer, a wearable computer, a handset, a messaging device, a camera device, and/or any other computing device. In some embodiments, the computing device 600 may be located in a data center, such as an enterprise data center (e.g., a data center owned and operated by a company and typically located on company premises), managed services data center (e.g., a data center managed by a third party on behalf of a company), a co-located data center (e.g., a data center in which data center infrastructure is provided by the data center host and a company provides and manages their own data center components (servers, etc.)), cloud data center (e.g., a data center operated by a cloud services provider that host companies applications and data), and an edge data center (e.g., a data center, typically having a smaller footprint than other data center types, located close to the geographic area that it serves).

The illustrative computing device 600 includes a processor 602, a memory 604, an input/output (I/O) subsystem 606, data storage 608, a communication circuit 610, a graphics processing unit 612, a camera 614, a microphone 616, a display 618, and one or more peripheral devices 620. In some embodiments, one or more of the illustrative components of the computing device 600 may be incorporated in, or otherwise form a portion of, another component. For example, the memory 604, or portions thereof, may be incorporated in the processor 602 in some embodiments. In some embodiments, one or more of the illustrative components may be physically separated from another component.

The processor 602 may be embodied as any type of processor capable of performing the functions described herein. For example, the processor 602 may be embodied as a single or multi-core processor(s), a single or multi-socket processor, a digital signal processor, a graphics processor, a neural network compute engine, an image processor, a microcontroller, or other processor or processing/controlling circuit. Similarly, the memory 604 may be embodied as any type of volatile or non-volatile memory or data storage capable of performing the functions described herein. In operation, the memory 604 may store various data and software used during operation of the computing device 600 such as operating systems, applications, programs, libraries, and drivers. The memory 604 is communicatively coupled to the processor 602 via the I/O subsystem 606, which may be embodied as circuitry and/or components to facilitate input/output operations with the processor 602, the memory 604, and other components of the computing device 600. For example, the I/O subsystem 606 may be embodied as, or otherwise include, memory controller hubs, input/output control hubs, firmware devices, communication links (i.e., point-to-point links, bus links, wires, cables, light guides, printed circuit board traces, etc.) and/or other components and subsystems to facilitate the input/output operations. The I/O subsystem 606 may connect various internal and external components of the computing device 600 to each other with use of any suitable connector, interconnect, bus, protocol, etc., such as an SoC fabric, PCIe®, USB2, USB3, USB4, NVMe®, Thunderbolt®, and/or the like. In some embodiments, the I/O subsystem 606 may form a portion of a system-on-a-chip (SoC) and be incorporated, along with the processor 602, the memory 604, and other components of the computing device 600 on a single integrated circuit chip.

The data storage 608 may be embodied as any type of device or devices configured for the short-term or long-term storage of data. For example, the data storage 608 may include any one or more memory devices and circuits, memory cards, hard disk drives, solid-state drives, or other data storage devices.

The communication circuit 610 may be embodied as any type of interface capable of interfacing the computing device 600 with other computing devices, such as over one or more wired or wireless connections. In some embodiments, the communication circuit 610 may be capable of interfacing with any appropriate cable type, such as an electrical cable or an optical cable. The communication circuit 610 may be configured to use any one or more communication technology and associated protocols (e.g., Ethernet, Bluetooth®, Wi-Fi®, WiMAX, near field communication (NFC), etc.). The communication circuit 610 may be located on silicon separate from the processor 602, or the communication circuit 610 may be included in a multi-chip package with the processor 602, or even on the same die as the processor 602. The communication circuit 610 may be embodied as one or more add-in-boards, daughtercards, network interface cards, controller chips, chipsets, specialized components such as a field-programmable gate array (FPGA) or application-specific integrated circuit (ASIC), or other devices that may be used by the computing device 600 to connect with another computing device. In some embodiments, communication circuit 610 may be embodied as part of a system-on-a-chip (SoC) that includes one or more processors or included on a multichip package that also contains one or more processors. In some embodiments, the communication circuit 610 may include a local processor (not shown) and/or a local memory (not shown) that are both local to the communication circuit 610. In such embodiments, the local processor of the communication circuit 610 may be capable of performing one or more of the functions of the processor 602 described herein. Additionally or alternatively, in such embodiments, the local memory of the communication circuit 610 may be integrated into one or more components of the computing device 600 at the board level, socket level, chip level, and/or other levels.

The graphics processing unit 612 is configured to perform certain computing tasks, such as video or graphics processing. The graphics processing unit 612 may be embodied as one or more processors, data processing unit, field-programmable gate arrays (FPGAs), application-specific integrated circuits (ASICs), and/or any combination of the above. In some embodiments, the graphics processing unit 612 may send frames or partial update regions to the display 618. For instance, the example graphics processing unit 612 includes a display engine 613, which may be embodied as hardware, firmware, software, virtualized hardware, emulated architecture, and/or a combination thereof, and is configured to determine frames to be sent to the display 618 and send the images to the display 618. In the illustrative embodiment, the display engine 613 is part of the graphics processing unit 612. In other embodiments, the display engine 613 may be part of the processor 602 or other component of the device 600.

In certain embodiments, the display engine 613 may include circuitry to implement aspects of the present disclosure, e.g., circuitry to implement the computational aspects described with respect to FIGS. 1A-1B above. For example, the display engine 613 may access frames stored in the memory 604, enhance the frames as described above, and then stream the frames to the display 618.

The camera 614 may include one or more fixed or adjustable lenses and one or more image sensors. The image sensors may be any suitable type of image sensors, such as a CMOS or CCD image sensor. The camera 614 may have any suitable aperture, focal length, field of view, etc. For example, the camera 614 may have a field of view of 60-110° in the azimuthal and/or elevation directions.

The microphone 616 is configured to sense sound waves and output an electrical signal indicative of the sound waves. In the illustrative embodiment, the computing device 600 may have more than one microphone 616, such as an array of microphones 616 in different positions.

The display 618 may be embodied as any type of display on which information may be displayed to a user of the computing device 600, such as a touchscreen display, a liquid crystal display (LCD), a thin film transistor LCD (TFT-LCD), a light-emitting diode (LED) display, an organic light-emitting diode (OLED) display, a cathode ray tube (CRT) display, a plasma display, an image projector (e.g., 2D or 3D), a laser projector, a heads-up display, and/or other display technology. The display 618 may have any suitable resolution, such as 7680×4320, 3840×2160, 1920×1200, 1920×1080, etc.

The display 618 includes a timing controller (TCON) 619, which includes circuitry to convert video data received from the graphics processing unit 612 into signals that drive a panel of the display 618. In some embodiments, the TCON 619 may also include circuitry to implement one or more aspects of the present disclosure. For example, the TCON 619 may include circuitry to implement the computational aspects described with respect to FIG. 4.

In some embodiments, the computing device 600 may include other or additional components, such as those commonly found in a computing device. For example, the computing device 600 may also have peripheral devices 620, such as a keyboard, a mouse, a speaker, an external storage device, etc. In some embodiments, the computing device 600 may be connected to a dock that can interface with various devices, including peripheral devices 620. In some embodiments, the peripheral devices 620 may include additional sensors that the computing device 600 can use to monitor the video conference, such as a time-of-flight sensor or a millimeter-wave sensor.

FIG. 7 is a block diagram of computing device components which may be included in a mobile computing device incorporating aspects of the present disclosure. Generally, components shown in FIG. 7 can communicate with other shown components, although not all connections are shown, for case of illustration. The components 700 comprise a multiprocessor system comprising a first processor 702 and a second processor 704 and is illustrated as comprising point-to-point (P-P) interconnects. For example, a point-to-point (P-P) interface 706 of the processor 702 is coupled to a point-to-point interface 707 of the processor 704 via a point-to-point interconnection 705. It is to be understood that any or all of the point-to-point interconnects illustrated in FIG. 7 can be alternatively implemented as a multi-drop bus, and that any or all buses illustrated in FIG. 7 could be replaced by point-to-point interconnects.

As shown in FIG. 7, the processors 702 and 704 are multicore processors. Processor 702 comprises processor cores 708 and 709, and processor 704 comprises processor cores 710 and 711. Processor cores 708-711 can execute computer-executable instructions.

Processors 702 and 704 further comprise at least one shared cache 712 and 714, respectively. The shared caches 712 and 714 can store data (e.g., instructions) utilized by one or more components of the processor, such as the processor cores 708-709 and 710-711. The shared caches 712 and 714 can be part of a memory hierarchy for the device. For example, the shared cache 712 can locally store data that is also stored in a memory 716 to allow for faster access to the data by components of the processor 702. In some embodiments, the shared caches 712 and 714 can comprise multiple cache layers, such as level 1 (L1), level 2 (L2), level 3 (L3), level 4 (LA), and/or other caches or cache layers, such as a last level cache (LLC).

Although two processors are shown, the device can comprise any number of processors or other compute resources. Further, a processor can comprise any number of processor cores. A processor can take various forms such as a central processing unit, a controller, a graphics processor, an accelerator (such as a graphics accelerator, digital signal processor (DSP), or artificial intelligence (AI) accelerator)). A processor in a device can be the same as or different from other processors in the device. In some embodiments, the device can comprise one or more processors that are heterogeneous or asymmetric to a first processor, accelerator, field programmable gate array (FPGA), or any other processor. There can be a variety of differences between the processing elements in a system in terms of a spectrum of metrics of merit including architectural, microarchitectural, thermal, power consumption characteristics and the like. These differences can effectively manifest themselves as asymmetry and heterogeneity amongst the processors in a system. In some embodiments, the processors 702 and 704 reside in a multi-chip package. As used herein, the terms “processor unit” and “processing unit” can refer to any processor, processor core, component, module, engine, circuitry or any other processing element described herein. A processor unit or processing unit can be implemented in hardware, software, firmware, or any combination thereof capable of.

Processors 702 and 704 further comprise memory controller logic (MC) 720 and 722. As shown in FIG. 7, MCs 720 and 722 control memories 716 and 718 coupled to the processors 702 and 704, respectively. The memories 716 and 718 can comprise various types of memories, such as volatile memory (e.g., dynamic random-access memories (DRAM), static random-access memory (SRAM)) or non-volatile memory (e.g., flash memory, solid-state drives, chalcogenide-based phase-change non-volatile memories). While MCs 720 and 722 are illustrated as being integrated into the processors 702 and 704, in alternative embodiments, the MCs can be logic external to a processor, and can comprise one or more layers of a memory hierarchy.

Processors 702 and 704 are coupled to an Input/Output (I/O) subsystem 730 via P-P interconnections 732 and 734. The point-to-point interconnection 732 connects a point-to-point interface 736 of the processor 702 with a point-to-point interface 738 of the I/O subsystem 730, and the point-to-point interconnection 734 connects a point-to-point interface 740 of the processor 704 with a point-to-point interface 742 of the I/O subsystem 730. Input/Output subsystem 730 further includes an interface 750 to couple I/O subsystem 730 to a graphics engine 752, which can be a high-performance graphics engine. The I/O subsystem 730 and the graphics engine 752 are coupled via a bus 754. Alternately, the bus 754 could be a point-to-point interconnection.

Input/Output subsystem 730 is further coupled to a first bus 760 via an interface 762. The first bus 760 can be a Peripheral Component Interconnect (PCI) bus, a PCI Express (PCIe) bus, another third generation I/O (input/output) interconnection bus or any other type of bus.

Various I/O devices 764 can be coupled to the first bus 760. A bus bridge 770 can couple the first bus 760 to a second bus 780. In some embodiments, the second bus 780 can be a low pin count (LPC) bus. Various devices can be coupled to the second bus 780 including, for example, a keyboard/mouse 782, audio I/O devices 788 and a storage device 790, such as a hard disk drive, solid-state drive or other storage device for storing computer-executable instructions (code) 792. The code 792 can comprise computer-executable instructions for performing technologies described herein. Additional components that can be coupled to the second bus 780 include communication device(s) or components 784, which can provide for communication between the device and one or more wired or wireless networks 786 (e.g. Wi-Fi, cellular or satellite networks) via one or more wired or wireless communication links (e.g., wire, cable, Ethernet connection, radio-frequency (RF) channel, infrared channel, Wi-Fi channel) using one or more communication standards (e.g., IEEE 802.11 standard and its supplements).

The device can comprise removable memory such as flash memory cards (e.g., SD (Secure Digital) cards), memory sticks, Subscriber Identity Module (SIM) cards). The memory in the computing device (including caches 712 and 714, memories 716 and 718 and storage device 790) can store data and/or computer-executable instructions for executing an operating system 794, or application programs 796. Example data includes web pages, text messages, images, sound files, video data, sensor data, or other data sets to be sent to and/or received from one or more network servers or other devices by the device via one or more wired or wireless networks, or for use by the device. The device can also have access to external memory (not shown) such as external hard drives or cloud-based storage.

The operating system 794 can control the allocation and usage of the components illustrated in FIG. 7 and support one or more application programs 796. The application programs 796 can include common mobile computing device applications (e.g., email applications, calendars, contact managers, web browsers, messaging applications) as well as other computing applications.

The device can support various input devices, such as a touchscreen, microphones, cameras (monoscopic or stereoscopic), trackball, touchpad, trackpad, mouse, keyboard, proximity sensor, light sensor, pressure sensor, infrared sensor, electrocardiogram (ECG) sensor, PPG (photoplethysmogram) sensor, galvanic skin response sensor, and one or more output devices, such as one or more speakers or displays. Any of the input or output devices can be internal to, external to or removably attachable with the device. External input and output devices can communicate with the device via wired or wireless connections.

In addition, the computing device can provide one or more natural user interfaces (NUIs). For example, the operating system 794 or application programs 796 can comprise speech recognition as part of a voice user interface that allows a user to operate the device via voice commands. Further, the device can comprise input devices and components that allows a user to interact with the device via body, hand, or face gestures.

The device can further comprise one or more communication components 784. The components 784 can comprise wireless communication components coupled to one or more antennas to support communication between the device and external devices. Antennas can be located in a base, lid, or other portion of the device. The wireless communication components can support various wireless communication protocols and technologies such as Near Field Communication (NFC), IEEE 1002.11 (Wi-Fi) variants, WiMax, Bluetooth, Zigbee, 4G Long Term Evolution (LTE), Code Division Multiplexing Access (CDMA), Universal Mobile Telecommunication System (UMTS) and Global System for Mobile Telecommunication (GSM). In addition, the wireless modems can support communication with one or more cellular networks for data and voice communications within a single cellular network, between cellular networks, or between the mobile computing device and a public switched telephone network (PSTN).

The device can further include at least one input/output port (which can be, for example, a USB, IEEE 1394 (FireWire), Ethernet and/or RS-232 port) comprising physical connectors; a power supply (such as a rechargeable battery); a satellite navigation system receiver, such as a GPS receiver; a gyroscope; an accelerometer; and a compass. A GPS receiver can be coupled to a GPS antenna. The device can further include one or more additional antennas coupled to one or more additional receivers, transmitters and/or transceivers to enable additional functions.

FIG. 7 illustrates one example computing device architecture. Computing devices based on alternative architectures can be used to implement technologies described herein. For example, instead of the processors 702 and 704, and the graphics engine 752 being located on discrete integrated circuits, a computing device can comprise a SoC (system-on-a-chip) integrated circuit incorporating one or more of the components illustrated in FIG. 7. In one example, an SoC can comprise multiple processor cores, cache memory, a display driver, a GPU, multiple I/O controllers, an AI accelerator, an image processing unit driver, I/O controllers, an AI accelerator, an image processor unit. Further, a computing device can connect elements via bus or point-to-point configurations different from that shown in FIG. 7. Moreover, the illustrated components in FIG. 7 are not required or all-inclusive, as shown components can be removed and other components added in alternative embodiments.

As used in any embodiment herein, the term “module” refers to logic that may be implemented in a hardware component or device, software or firmware running on a processor, or a combination thereof, to perform one or more operations consistent with the present disclosure. Software may be embodied as a software package, code, instructions, instruction sets and/or data recorded on non-transitory computer-readable storage mediums. Firmware may be embodied as code, instructions or instruction sets and/or data that are hard-coded (e.g., nonvolatile) in memory devices. As used in any embodiment herein, the term “circuitry” can comprise, for example, singly or in any combination, hardwired circuitry, programmable circuitry such as computer processors comprising one or more individual instruction processing cores, state machine circuitry, and/or firmware that stores instructions executed by programmable circuitry. Modules described herein may, collectively or individually, be embodied as circuitry that forms a part of one or more devices. Thus, any of the modules can be implemented as circuitry, such as continuous itemset generation circuitry, entropy-based discretization circuitry, etc. A computer device referred to as being programmed to perform a method can be programmed to perform the method via software, hardware, firmware or combinations thereof.

Disclosed methods can be implemented as computer-executable instructions or a computer program product. Such instructions can cause a computer or one or more processors capable of executing computer-executable instructions to perform any of the disclosed methods. Generally, as used herein, the term “computer” refers to any computing device or system described or mentioned herein, or any other computing device. Thus, the term “computer-executable instruction” refers to instructions that can be executed by any computing device described or mentioned herein, or any other computing device.

The computer-executable instructions or computer program products as well as any data created and used during implementation of the disclosed technologies can be stored on one or more tangible or non-transitory computer-readable storage media, such as optical media discs (e.g., DVDs, CDs), volatile memory components (e.g., DRAM, SRAM), or non-volatile memory components (e.g., flash memory, solid state drives, chalcogenide-based phase-change non-volatile memories). Computer-readable storage media can be contained in computer-readable storage devices such as solid-state drives, USB flash drives, and memory modules. Alternatively, the computer-executable instructions may be performed by specific hardware components that contain hardwired logic for performing all or a portion of disclosed methods, or by any combination of computer-readable storage media and hardware components.

The computer-executable instructions can be part of, for example, a dedicated software application or a software application that is accessed via a web browser or other software application (such as a remote computing application). Such software can be read and executed by, for example, a single computing device or in a network environment using one or more networked computers. Further, it is to be understood that the disclosed technology is not limited to any specific computer language or program. For instance, the disclosed technologies can be implemented by software written in C++, Java, Perl, Python, JavaScript, Adobe Flash, or any other suitable programming language. Likewise, the disclosed technologies are not limited to any particular computer or type of hardware.

Furthermore, any of the software-based embodiments (comprising, for example, computer-executable instructions for causing a computer to perform any of the disclosed methods) can be uploaded, downloaded or remotely accessed through a suitable communication means. Such suitable communication means include, for example, the Internet, the World Wide Web, an intranet, cable (including fiber optic cable), magnetic communications, electromagnetic communications (including RF, microwave, and infrared communications), electronic communications, or other such communication means.

As used in this application and in the claims, a list of items joined by the term “and/or” can mean any combination of the listed items. For example, the phrase “A, B and/or C” can mean A; B; C; A and B; A and C; B and C; or A, B, and C. Further, as used in this application and in the claims, a list of items joined by the term “at least one of” can mean any combination of the listed terms. For example, the phrase “at least one of A, B, or C” can mean A; B; C; A and B; A and C; B and C; or A, B, and C. Moreover, as used in this application and in the claims, a list of items joined by the term “one or more of” can mean any combination of the listed terms. For example, the phrase “one or more of A, B and C” can mean A; B; C; A and B; A and C; B and C; or A, B, and C.

The disclosed methods, apparatuses and systems are not to be construed as limiting in any way. Instead, the present disclosure is directed toward all novel and nonobvious features and aspects of the various disclosed embodiments, alone and in various combinations and subcombinations with one another. The disclosed methods, apparatuses, and systems are not limited to any specific aspect or feature or combination thereof, nor do the disclosed embodiments require that any one or more specific advantages be present or problems be solved.

Although the operations of some of the disclosed methods are described in a particular, sequential order for convenient presentation, it is to be understood that this manner of description encompasses rearrangement, unless a particular ordering is required by specific language set forth herein. For example, operations described sequentially may in some cases be rearranged or performed concurrently. Moreover, for the sake of simplicity, the attached figures may not show all the various ways in which the disclosed methods can be used in conjunction with other methods.

The following examples pertain to additional embodiments of technologies disclosed herein.

Example 1 is a display panel comprising: a substrate comprising a substantially transparent material; a plurality of self-emissive elements, wherein the self-emissive elements are substantially transparent; and a layer between the substrate and the self-emissive elements, wherein the layer is electrically controllable to have a transmissivity below about 10% or above about 70%.

Example 2 includes the display panel of Example 1, wherein the layer comprises electrochromic glass.

Example 3 includes the display panel of Example 1, wherein the layer comprises liquid crystals.

Example 4 includes the display panel of Example 3, wherein the layer comprising liquid crystals comprises polymer-dispersed liquid crystals (PDLC).

Example 5 includes the display panel of any one of Examples 1-4, wherein the layer is between the substrate and the self-emissive elements.

Example 6 includes the display panel of any one of Examples 1-5, wherein the layer is a first layer, and the display comprises a second layer comprising electrodes electrically connected to the self-emissive elements, wherein the first layer is adjacent to the second layer.

Example 7 includes the display panel of Example 6, wherein the first layer is electrically connected to the second layer.

Example 8 includes the display panel of any one of Examples 1-7, wherein the self-emissive elements are arranged to emit in a direction opposite the layer.

Example 9 includes the display panel of any one of Examples 1-8, wherein the self-emissive elements comprise organic light-emitting diodes (OLEDs).

Example 10 includes the display panel of any one of Examples 1-8, wherein the self-emissive elements comprise micro light-emitting diodes (uLEDs).

Example 11 is a device comprising: a display panel comprising: self-emissive elements; and a layer comprising a material with electrically controllable opacity; wherein the display panel is to be substantially transparent in a first state of the layer and substantially opaque in a second state of the layer; and control circuitry to provide signals to the electrically switchable layer to control an opacity of the layer.

Example 12 includes the device of Example 11, wherein the layer comprises electrochromic glass.

Example 13 includes the device of Example 11, wherein the layer comprises polymer-dispersed liquid crystals (PDLC).

Example 14 includes the device of any one of Examples 11-13, wherein the self-emissive elements are arranged to emit in a direction opposite the layer.

Example 15 includes the device of any one of Examples 11-14, further comprising an electrode layer electrically connected to the self-emissive elements, wherein the electrode layer is adjacent to the electrically controllable layer.

Example 16 includes the device of Example 15, wherein the control circuitry is electrically connected to the electrode layer and the electrically switchable layer.

Example 17 includes the device of any one of Examples 11-16, wherein the self-emissive elements comprise organic light-emitting diodes (OLEDs).

Example 18 includes the device of any one of Examples 11-16, wherein the self-emissive elements comprise micro light-emitting diodes (uLEDs).

Example 19 includes the device of any one of Examples 11-18, further comprising processor circuitry and memory coupled to the display panel.

Example 20 includes the device of any one of Examples 11-19, wherein the device is a computing device.

Example 21 is a system comprising: memory; a processor; a display panel according to any one of Examples 1-10; and control circuitry to electrically control an opacity of the layer.

Example 22 is a method comprising: receiving a frame to be displayed on a transparent self-emissive display panel; and causing the frame to be displayed on the display panel, comprising controlling a layer of the display panel comprising a material with electrically controllable opacity based on content within the frame.

Example 23 includes the method of Example 22, wherein the layer of the display panel comprising a material with electrically controllable opacity is a first layer, and causing the frame to be displayed on the display panel further comprises controlling a second layer of the display panel comprising self-emissive elements.

Example 24 includes the method of Example 22 or 23, wherein controlling the layer of the display panel comprising a material with electrically controllable opacity comprises modifying the opacity in one or more regions of the layer based on an analysis of content within the frame.

Example 25 includes the method of any one of Examples 22-24, wherein controlling the layer of the display panel comprising a material with electrically controllable opacity comprises darkening regions of the layer in which text is in the frame.

Example 26 includes the method of any one of Examples 22-24, wherein controlling the layer of the display panel comprising a material with electrically controllable opacity comprises identifying one or more regions of the frame comprising dark content to be displayed, and darkening regions of the layer in which the dark content is in the frame.

Example 27 includes the method of any one of Examples 22-26, further comprising providing the frame as input to a neural network, wherein controlling the second layer of the display panel is based on an output of the neural network.

Example 28 is an apparatus to implement the method of any one of Examples 22-27.

Example 29 is one or more non-transitory computer readable medium comprising instructions that, when executed by processing circuitry, cause the processing circuitry to perform the method of any one of Examples 22-27.

1. A display panel comprising:
a substrate comprising a substantially transparent material;
a plurality of self-emissive elements, wherein the self-emissive elements are substantially transparent; and
a layer between the substrate and the self-emissive elements, wherein the layer is electrically controllable to have a transmissivity below about 10% or above about 70%.

2. The display panel of claim 1, wherein the layer comprises electrochromic glass.

3. The display panel of claim 1, wherein the layer comprises liquid crystals.

4. The display panel of claim 3, wherein the layer comprising liquid crystals comprises polymer-dispersed liquid crystals (PDLC).

5. The display panel of claim 1, wherein the layer is between the substrate and the self-emissive elements.

6. The display panel of claim 1, wherein the layer is a first layer, and the display comprises a second layer comprising electrodes electrically connected to the self-emissive elements, wherein the first layer is adjacent to the second layer.

7. The display panel of claim 6, wherein the first layer is electrically connected to the second layer.

8. The display panel of claim 1, wherein the self-emissive elements are arranged to emit in a direction opposite the layer.

9. The display panel of claim 1, wherein the self-emissive elements comprise organic light-emitting diodes (OLEDs) or micro light-emitting diodes (uLEDs).

10. A device comprising:
a display panel comprising:
self-emissive elements; and
a layer comprising a material with electrically controllable opacity;
wherein the display panel is to be substantially transparent in a first state of the layer and substantially opaque in a second state of the layer; and
control circuitry to provide signals to the display panel to control an opacity of the material with electrically controllable opacity.

11. The device of claim 10, wherein the layer comprises electrochromic glass.

12. The device of claim 10, wherein the layer comprises polymer-dispersed liquid crystals (PDLC).

13. The device of claim 10, wherein the self-emissive elements are arranged to emit in a direction opposite the layer.

14. The device of claim 10, further comprising an electrode layer electrically connected to the self-emissive elements, wherein the electrode layer is adjacent to the electrically controllable layer.

15. The device of claim 10, further comprising processor circuitry and memory coupled to the display panel.

16. The device of claim 10, wherein the device is a computing device.

17. A system comprising:
memory;
a processor;
a display panel comprising:
a first layer comprising transparent self-emissive elements; and
a second layer comprising a material with electrically controllable opacity; and
control circuitry to electrically control an opacity of the second layer.

18. The system of claim 17, wherein the second layer comprises electrochromic glass or polymer-dispersed liquid crystals (PDLC).

19. The system of claim 17, further comprising a layer of electrodes between the first layer and the second layer, the electrodes electrically conductively coupled to the first layer and the second layer.

20. The system of claim 17, wherein the self-emissive elements comprise organic light-emitting diodes (OLEDs) or micro light-emitting diodes (uLEDs).
